(19) United States
(12) Patent Application Publication
(10) Pub. No.: US 2022/0274664 A1
(43) Pub. Date: Sep. 1, 2022

(54) Physiotherapeutic Conveyance

(71) Applicant: David Ingerson, Bethania, Queensland (AU)

(72) Inventor: David Ingerson, Bethania, Queensland (AU)

(21) Appl. No.: 17/624,918

(22) PCT Filed: Jul. 3, 2020
(86) PCT No.: PCT/AU2020/050704

§ 371 Date: Jan. 5, 2022

(30) Foreign Application Priority Data
Jul. 5, 2019 (AU) 2019 902403

(51) Int. Cl. B62K 3/00; A63B 23/035; A63B 23/04; B62K 21/00; B62K 5/023; B62K 5/08; B62J 17/083; B62K 15/00

(52) U.S. Cl. CPC B62K 3/005; A63B 23/03541; A63B 23/0476; B62K 21/00; B62K 5/023; B62K 5/08; B62J 17/083; B62K 15/006

(57) ABSTRACT

A physiotherapeutic conveyance with a forwardly mounted wheel, a chassis relative to which said forwardly mounted wheel is mounted, a seat mounted relative to said chassis on a seating mount, a rear axle associated with a pair of outwardly disposed first and second rear wheels, and a steering assembly associated with said pair of outwardly disposed rear wheels, wherein said steering assembly comprises a steering mechanism operable to adjust the orientation of the rear wheels.

### FIELD OF INVENTION

The disclosed embodiments relate to a physiotherapeutic conveyance, and more particularly to a physiotherapeutic conveyance that facilitates therapy through muscle movement, particularly through the legs and/or back, in persons with physical and/or intellectual disabilities or injuries.

### BACKGROUND

In many instances, persons having limb and muscle related conditions require surgical intervention. Frequent physiotherapy may help to reduce the incidence of surgical intervention, which in many instances can be quite high, required on those with such limb and muscle related medical conditions.

In Australia 300,000 people suffer from Cerebral Palsy (CP) alone, making it one of the most common disabilities in Australia in the younger population. Cerebral palsy is an umbrella term for a group of disorders. It is a condition that is permanent, but not unchanging, and is a life-long physical disability due to damage of the developing brain. In most cases, brain injury leading to cerebral palsy occurs during pregnancy. Cerebral palsy, except in its mildest forms, can be evident in the first 12-18 months. Motor disability can range from minimal to profound, depending on the individual. It can range from weakness in one hand, to an almost complete lack of voluntary movement. People with significant physical disability may require 24 hour a day care. People with cerebral palsy are likely to also have other impairments in addition to their motor disability. Spastic hemiplegia, where one half of the body has difficulty with voluntary movement, is the most common presentation of cerebral palsy. Approximately 40% of people with cerebral palsy have hem iplegia. There is no known cure.

One in three people with cerebral palsy are non-ambulatory, that is use a wheelchair and, in Australia, 34,000 are children. People with cerebral palsy have a much higher chance of suffering additional complications (epilepsy, intellectual impairment, etc.). Physiotherapy can be both painful and expensive in terms of both time and resources. Simple physiotherapy that can be safely delivered in an enjoyable way by parents and careers may allow for an easier rehabilitation or treatment process.

Many specialists and groups in Australia and worldwide recommend using “riding therapy”. Specialist studies of sufferers of cerebral palsy who undertake this therapy for 20-30 mins at a minimum level of twice per week have found this can help reduce the need for surgeries to hips and legs.

Currently bikes are used mainly for younger children due to the propensity of the bikes to topple over when turned and difficulties associated with configuring the bikes to a particular user. For example, bikes may take an hour or more to set up. It may also be difficult to get a child or person on the bike safely. For these reasons, bikes are rarely used beyond the age of 8 or 9 and are generally not used for children or adults with significant intellectual impairment, mainly due to the fact they can topple over and are unsafe for those with reduced back control.

The subject matter claimed herein is not limited to embodiments that solve any disadvantages or that operate only in environments such as those described above. Rather, this background is only provided to illustrate exemplary technology areas where some embodiments described herein may be practiced. For example, the physiotherapeutic conveyance disclosed herein is not limited to the treatment of persons suffering from cerebral palsy. It may be equally applicable to the treatment of persons suffering from any number of medical conditions or those suffering from injuries that may be treated, for example, by physiotherapy.

Various aspects and embodiments of the invention will now be described.

### SUMMARY OF INVENTION

As mentioned above, the inventive embodiments relate to a physiotherapeutic conveyance. In particular, they relate to a physiotherapeutic conveyance that facilitates therapy through muscle movement, particularly through the legs and/or back, in persons with physical and/or intellectual disabilities or injuries.

According to one aspect there is provided a physiotherapeutic conveyance comprising:
a forwardly mounted wheel;
a chassis relative to which the forwardly mounted wheel is mounted;
a seat mounted relative to the chassis on a seating mount;
a rear axle associated with a pair of outwardly disposed first and second rear wheels; and
a steering assembly associated with the pair of outwardly disposed rear wheels,
wherein the steering assembly comprises a steering mechanism operable to adjust the orientation of the rear wheels.

Preferably, the physiotherapeutic conveyance is adapted to exercise the legs of a user. To that end, in a preferred embodiment the physiotherapeutic conveyance further comprises a pair of pedals and cranks associated with opposing sides of a hub of the forwardly mounted wheel. In certain embodiments, each pedal and crank can be independently engaged and disengaged. For example, each pedal and crank may be independently engaged and disengaged through a respective clutch disposed on the hub of the forwardly mounted wheel and on either side of the forwardly mounted wheel. Each clutch may comprise a collar mounted on the hub of the forwardly mounted wheel, the collar comprising a plurality of locking pins, and a complementary engagement associated with a respective pedal and crank, the complementary engagement comprising a plurality of apertures adapted to engage the plurality of locking pins.

In preferred embodiments, the forwardly mounted wheel is mounted relative to the chassis through a front fork. The front fork may comprises a pair of blades that extend either side of the forwardly mounted wheel, each of the blades comprising an extension portion that facilitates adjustment of a distance between the forwardly mounted wheel and the chassis. That is, the forwardly mounted wheel may be adapted to translate away from and towards the chassis. This may be advantageous in making the physiotherapeutic conveyance suitable for a wide variety of users. For example, this may be facilitated by providing each of the extension portions with a plurality of apertures through which the forwardly mounted wheel can be mounted.

A proximal end of the front fork may be hingedly mounted on the chassis through a front fork hinge. In certain embodiments, the front fork hinge comprises a lock adapted to lock the front fork in an extended orientation for use and a retracted orientation for storage.

The chassis may comprise a chassis frame comprising a body portion relative to which the seat is mounted and a rear portion that is associated with the rear axle. According to this embodiment, the body portion of the chassis frame extends horizontally under the seat and the rear portion of the chassis frame extends at an incline to the body portion.

In order to provide more flexibility in use, the seat is preferably slidably mounted on the seating mount above the body portion of the chassis frame. For example, the seat may comprise a pair of guides disposed on lateral undersides thereof which are respectively mounted in a pair of runners disposed on the seating mount under the lateral sides of the seat. Preferably the seat comprises a leaver arm operable to engage and disengage notches in the runners.

In preferred embodiments, a front portion of the seat is height adjustable. For example, an underside of the front portion of the seat may comprise a pair of notched arms extending therefrom, wherein notches in the notched arms are adapted to releasably engage a lateral pin. The lateral pin may extend from the seating mount or the chassis. A back support portion of the seat may also be adjustable to facilitate adjustment of the rake of the seat. For example, the back portion may be coupled to a telescopic extension that extends into a housing associated with an arm that extends from seating mount or the chassis. It is also envisaged that the height and rake of the seat may be electronically adjustable. For example, the mechanical options outlined above may be replaced with linear actuators that may be actuated with, for example, a remote handset. This may facilitate adjustment of the seat with a person in situ, which may be particularly advantageous.

In certain embodiments, the rear axle extends laterally and is fixedly connected with the chassis. The first and second rear wheels are preferably pivotally mounted on the rear axle. In this embodiment, the rear wheels pivot to facilitate steering while the rear axle remains static.

The steering mechanism may comprise first and second struts each mounted at one end on a centre pivot and on respective opposing ends mounted on first and second pivots associated with the first and second wheels respectively. The centre pivot and/or the first and second pivots associated with the first and second wheels are preferably provided with a plurality of apertures to which the first and second struts can be mounted. In this way, the mounting of the struts can be adjusted, thereby adjusting the degree of turning available to a user. The centre pivot may be connected to an upright section that extends upwardly and is connected to a handle bar.

According to this embodiment, the physiotherapeutic conveyance may further comprise a first breaking system associated with the handle bar and the first and second rear wheels. The braking system may comprise brake levers mounted on the handle bar, brake cables coupled with the brake levers and brakes coupled with the brake cables and mounted on the first and second rear wheels respectively.

The steering mechanism may further or alternatively comprise third and fourth struts each mounted at one end on the centre pivot and on respective opposing ends mounted on first and second hand levers disposed either side of the seat. A second breaking system may be associated with the hand levers and the first and second rear wheels. According to this embodiment, the second braking system may comprise brake levers mounted on the hand levers, brake cables coupled with the brake levers and brakes coupled with the brake cables and mounted on the first and second rear wheels respectively.

In preferred embodiments, the physiotherapeutic conveyance further comprises a control arm pivotally mounted at one end on a pivot associated with one of the first and second rear wheels and connected at an opposing end to a seat mounting rail extending from the seating mount on which the seat is mounted, whereby steering of the first and second rear wheels imparts a tilt to the seat. Preferably, the pivot on which the control arm is mounted comprises a plurality of apertures to which the one end of the control can be mounted. This advantageously facilitates adjustment of the degree of tilt applied to the seat, if any.

### BRIEF DESCRIPTION OF ACCOMPANYING DRAWINGS

To further clarify various aspects of some embodiments of the present invention, a more particular description of the invention will be rendered by references to specific embodiments thereof, which are illustrated in the appended drawings. It should be appreciated that these drawings depict only typical embodiments of the invention and are therefore not to be considered limiting on its scope. In the accompanying drawings:

FIG. 1 illustrates a perspective side view of a physiotherapeutic conveyance according to an embodiment.

FIG. 2 illustrates a front side view of a forwardly mounted wheel and clutch mechanism.

FIG. 3 illustrates an opposing front side of the forwardly mounted wheel of FIG. 2.

FIG. 4 illustrates an upper side view of a proximal end of a front fork hingedly mounted on a chassis through a front fork hinge.

FIG. 5 illustrates a side view of a guide disposed on a lateral underside of a seat and mounted in a runner.

FIG. 6 illustrates an upper side view of a lever for adjusting the position of the seat.

FIG. 7 illustrates a side view of notched arms releasably engaging a lateral pin extending from the chassis.

FIG. 8 illustrates a side view of telescopic extension mounted on the back of the seat that extends into a housing associated with an arm that extends from the chassis.

FIG. 9 illustrates a rear view of a rear axle and first and second rear wheels, associated with a steering mechanism, braking system and control arm

FIG. 10 illustrates a perspective view of a pivot associated with a rear wheel.

FIG. 11 illustrates a top view of the pivot of FIG. 10.

FIG. 12 illustrates a perspective side view of the physiotherapeutic conveyance with the rear wheels turned fully to the right.

FIG. 13 illustrates a perspective side view of the physiotherapeutic conveyance with the rear wheels turned fully to the left.

FIG. 14 illustrates a perspective side view of the physiotherapeutic conveyance with a canopy attached.

### DETAILED DESCRIPTION

Hereinafter, this specification will describe the present invention according to the preferred embodiments. It is to be understood that limiting the description to the preferred embodiments of the invention is merely to facilitate discussion of the present invention and it is envisioned without departing from the scope of the appended claims.

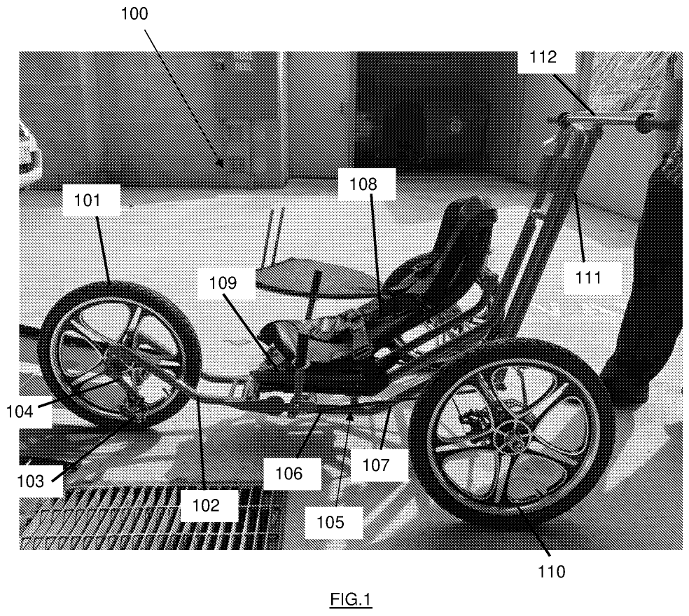

Referring to FIG. 1, a physiotherapeutic conveyance in the form of a tricycle 100 is illustrated. A brief discussion of the tricycle 100 will be provided, followed by a more detailed description of the various illustrate components.

The tricycle 100 includes a forwardly mounted or front wheel 101, mounted on a front fork 102. Pedals 103 and cranks 104 are mounted on either side of the front wheel 101 may facilitate drive to the front wheel 101. The front fork 102 is hingedly connected to a chassis frame 105. The chassis frame 105 includes a body portion 106 and a rear portion 107 that extends at an incline from the body portion 106. Above the body portion 106, a seat 108 is mounted on a seating mount 109.

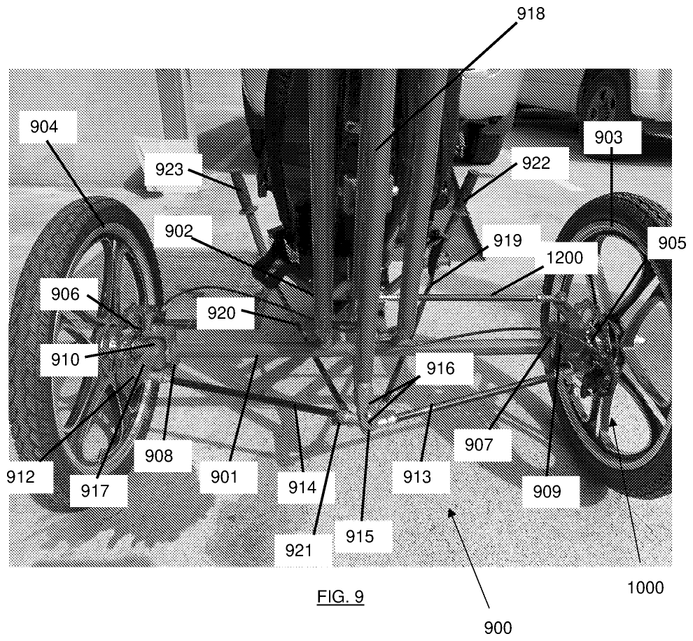

A pair of outwardly disposed first and second rear wheels 110 are mounted relative to a rear axle (illustrated in FIG. 9 in more detail). Steering of the rear wheels 110 is facilitated by a steering assembly associated with the pair of outwardly disposed rear wheels 110. In this embodiment, the steering assembly comprises two steering mechanism operable to adjust the orientation of the rear wheels. Each of these will be discussed in more detail below. Briefly, a first steering mechanism includes an upright 111 that is indirectly connected to the rear wheels 110 and which extends to a handle bar 112. A second steering mechanism includes a pair of hand levers that are again indirectly connected to the rear wheels 110.

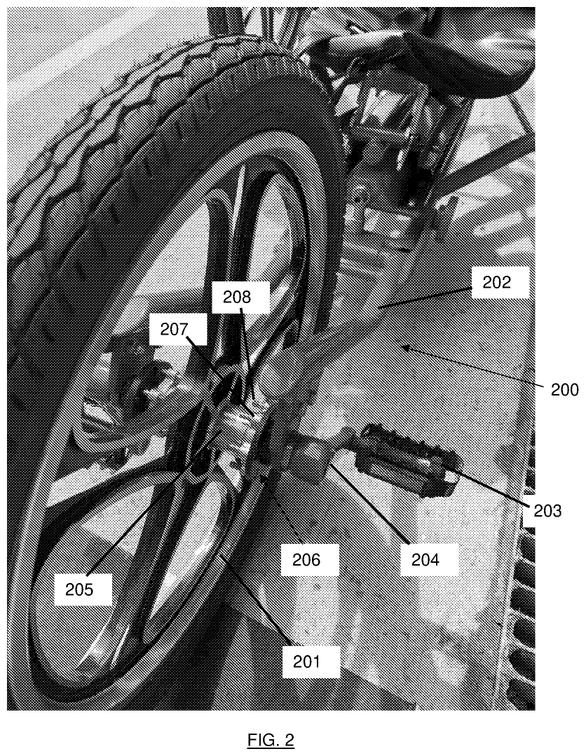

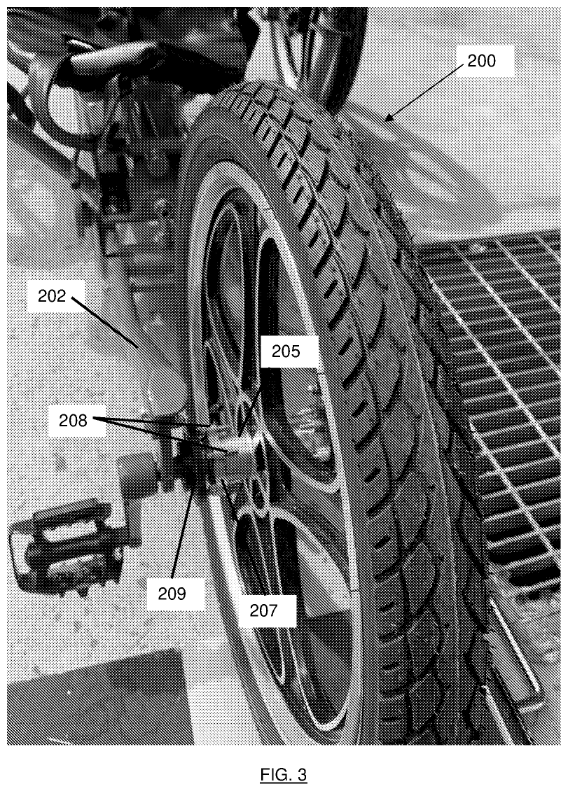

Referring to FIGS. 2 and 3, a front wheel assembly 200 of the tricycle 100 is illustrated in more detail. The front wheel assembly includes a front wheel 201, a front fork 202, and a pair of pedals 203 and cranks 204 associated with opposing sides of a 205 hub of the front wheel 201. Each pedal 203 and crank 204 can be independently engaged and disengaged. Specifically, each pedal 203 and crank 204 may be independently engaged and disengaged through a respective clutch 206 disposed on the hub 205 of the front wheel 201 and on either side of the front wheel 201. Each clutch 206 comprises a collar 207 mounted on the hub 205. The collar 207 is an annular ring that is secured to the hub 205 and includes a plurality of locking pins 208. A complementary engagement 209 is provided that includes a plurality of apertures that are adapted to engage the plurality of locking pins 208. When the locking pins 208 are inserted into the apertures of the engagement 209, the respective pedal 203 and crank 204 is engaged. This may be advantageous in situations where a user has limited use of one leg or requires therapy on one leg or both legs. For example, if a user of the tricycle 100 has use of only their left leg, the left pedal 203 and crank 204 can be engaged to exercise that leg, while the right pedal 203 and crank 204 can be left disengaged. If a user does not have use of their legs, or does not require therapy on their legs both pedals 203 and 204 can be disengaged. In addition, the cranks 204 may be provided with a number of tapped holes (not shown) to allow the pedals to be fitted at any of these, thus allowing for differing levels of leg movement range.

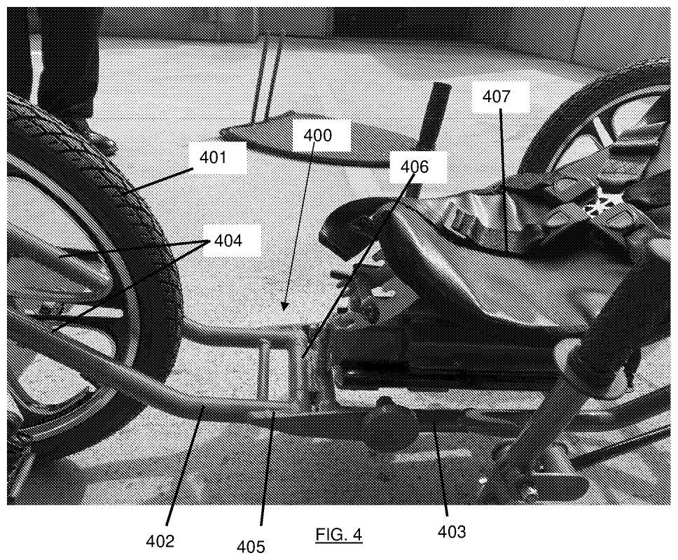

FIG. 4 illustrates a fork mounting 400 of a front fork 402 to a chassis frame 403. As illustrated, the front forks 402 comprises a pair of blades 404 that extend either side of the front wheel 401. A proximal end 405 of the front fork 402 may be hingedly mounted on the chassis frame 403 through a front fork hinge 406. As such, the front fork 402 may lock into place in an operating or extended orientation, as illustrated, for use and may fold up onto the seat 407 of the tricycle 100 in a retracted orientation for storage.

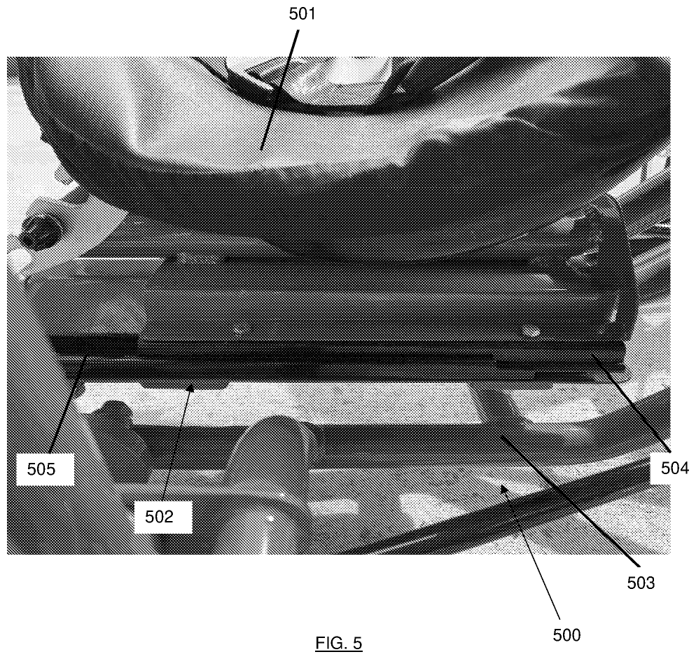

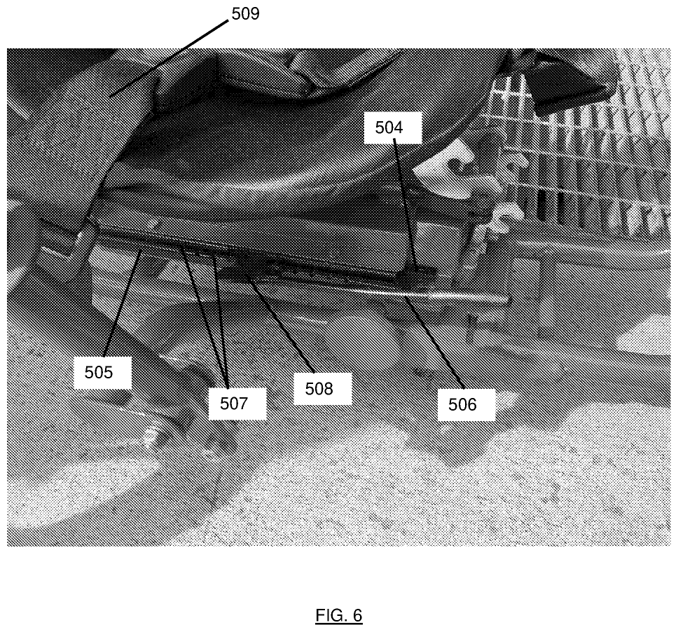

Referring to FIGS. 5 and 6, a slidable mounting assembly 500 is illustrated. As illustrated, the seat 501 is slidably mounted on a seating mount 502 above a body portion 503 of the chassis frame. For example, the slidable mounting assembly 500 may comprise a pair of guides 504 disposed on lateral sides of the slidable mounting assembly 500 which are respectively mounted in a pair of runners 505 disposed on the seating mount 502 under the lateral sides of the seat 501. A leaver arm 506 is operable to engage and disengage notches 507 in the runners 505. As such, when the lever arm 506 is pulled upward an engagement end 508 of the lever arm 506 disengages with the notches 507 and the runners 505 can slide within the guides 504.

The seat 501 can also be provided with a seat belt 509 for securing a user within the seat 501 during treatment. The seat belt 509 may be a five point seat belt as best illustrated in FIG. 4, or may be a three point or lap/sash belt. The seat belt 509 may be particularly useful when users have uncontrolled movement, or where lateral tilting of the seat 501 is employed to engage a user's back muscles, as discussed in more detail below.

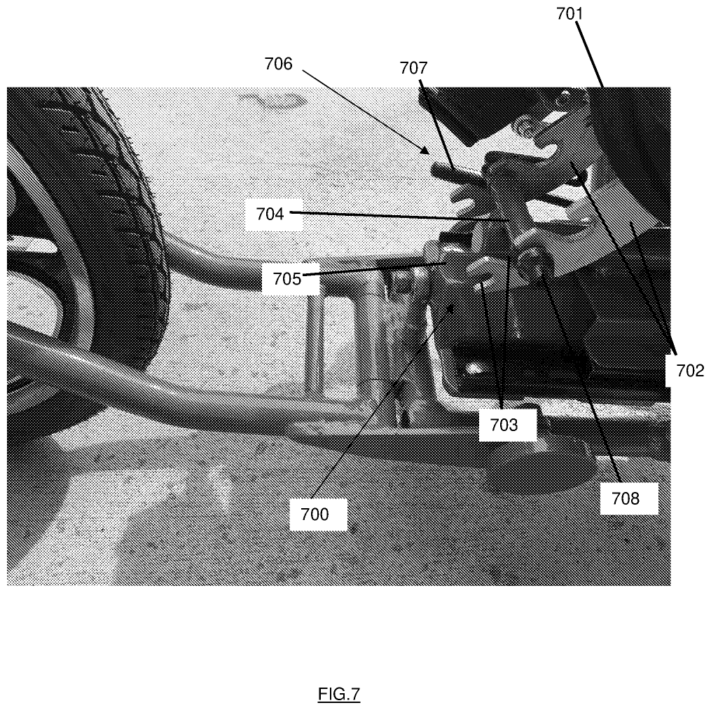

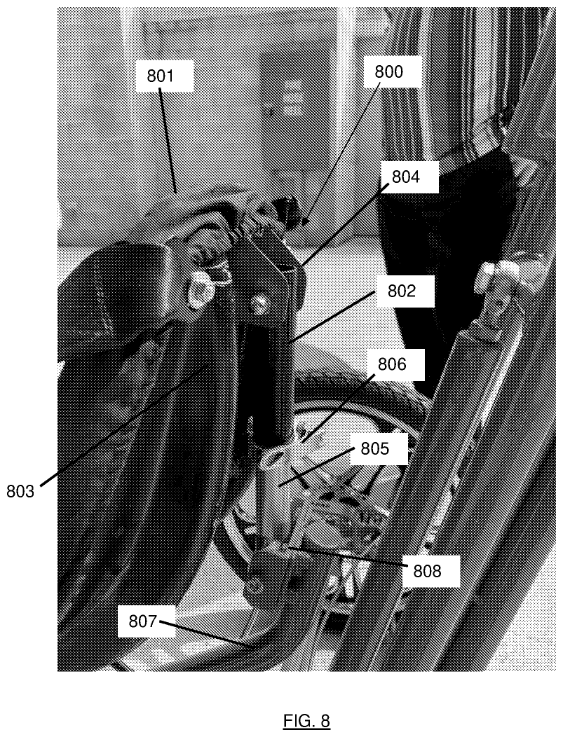

FIGS. 7 and 8 illustrate mechanisms for adjusting the height and tilt of the seat. While mechanical mechanisms will be described with reference to FIGS. 7 and 8, it is considered that these mechanical mechanisms may be replaced with electronic options, for example linear actuators.

Referring to FIG. 7, a height adjustment assembly 700 is illustrated that facilitates adjustment of the height of the front of the seat 701. The height adjustment assembly 700 includes a pair of notched arms 702 extending from an underside of the front of the seat 701. Notches 703 in the notched arms 702 are adapted to releasably engage a lateral pin 704 connected to and extending above the seating mount 705. In the illustrated embodiment, the lateral pin 704 can be engaged with the notched arms 702 via a quick snap engagement 706 that includes a lever 707 (also seen in FIG. 6) that is threadably coupled with a cap nut 708.

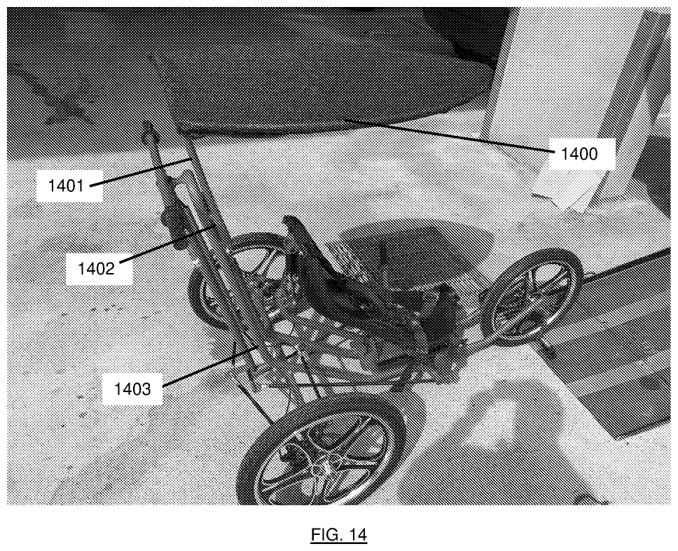

With reference to FIG. 8, a rake adjustment mechanism 800 is illustrated for adjusting the rake of the seat 801. A telescopic extension 802 is coupled to a back support portion 803 of the seat 801 through a hinge 804. The telescopic extension 802 extends into a housing 805 that is provided with a quick snap engagement 806 that is operable to engage the telescopic extension 802 within the housing 805. The housing 805 is coupled with an arm 807 through a hinge 808, the arm 807 extending from the seating mount (best seen in FIGS. 1 and 14).

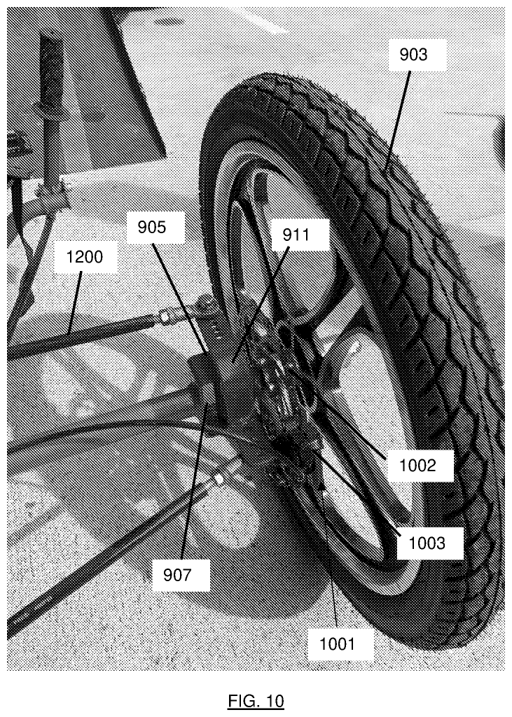

FIGS. 9-11 illustrate a steering assembly 900 and braking assembly 1000 of the tricycle. Referring firstly to the steering assembly 900, a rear axle 901 extends laterally and is fixedly connected with a rear portion 902 of the chassis. First and second rear wheels 903, 904 are pivotally mounted on the rear axle on rear wheel mounts 905, 906. The rear wheels 903, 904 therefore pivot to facilitate steering of the tricycle while the rear axle remains static. The mounts 905, 906 include a C-joint 907, 908 and a pivot 909, 910 to which the wheel 903, 904 is mounted. An S-shaped bracket 911 (best seen in FIG. 10) extends from the pivot 909 of the mount 905 associated with the first wheel 903. An arm 912 extends from the pivot 910 of the mount 906 associated with the second wheel 904.

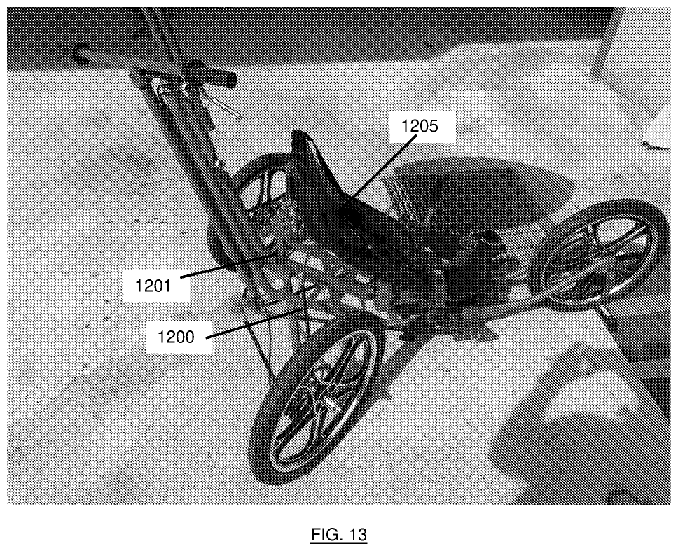

First and second struts 913, 914 are mounted at one end on a centre pivot 915 and on respective opposing ends on the S-shaped bracket 911 and the arm 912 of the pivots 909, 910 respectively. The centre pivot 915 includes a plurality of apertures 916 to which the first and second struts 913, 914 can be mounted. Likewise, the S-shaped bracket 911 and the arm 912 are provided with a plurality of apertures 917 to which the first and second struts 913, 914 respectively can be mounted. The mounting of the first and second struts 913, 914 can therefore be adjusted, at both the centre pivot 915 and the S-shaped bracket 911 and the arm 912, thereby adjusting the degree of turning available to a user. The centre pivot 915 is connected to an upright section 918 that extends upwardly and is connected to a handle bar (best illustrated in FIG. 13). Thus, turning of the handle bar actuated the first and second struts 913, 914 resulting in turning of the rear wheels 903, 904.

The steering assembly 900 further comprises third and fourth struts 919, 920, each mounted at one end on a pivoting arm 921 of the centre pivot 915 that is secured to the upright section and on respective opposing ends on first and second hand levers 922, 923 disposed either side of the seat. A user, seated on the seat, may move the hand levers 922, 923 in opposing forward and rearward directions to actuate the third and fourth struts 919, 920 causing the pivoting arm 921 to pivot resulting in turning of the rear wheels 903, 904 to turn.

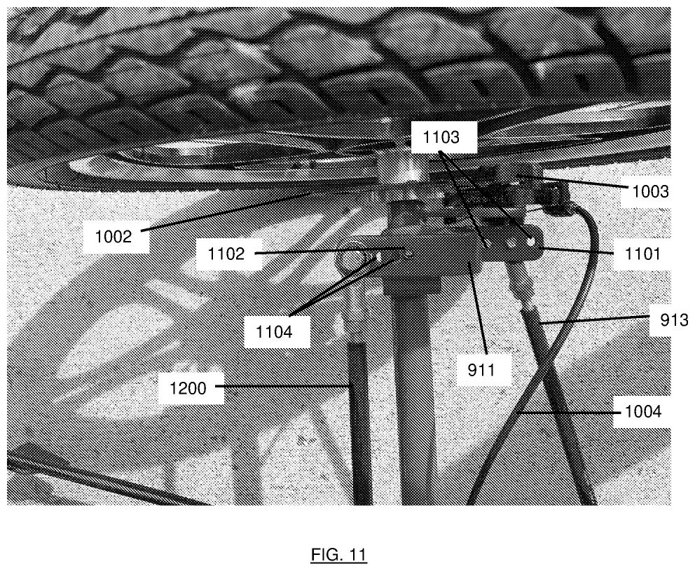

The braking assembly 1000 will be described with reference to FIGS. 10 and 11, which illustrate a brake mechanism 1001 mounted on the first rear wheel 903. It will be appreciated that a like brake mechanism is mounted on the second rear wheel 904. The brake mechanism 1001 includes a brake disc 1002 and a calliper 1003 disposed about the brake disc 1002. A brake cable 1004 is coupled with the calliper 1003 and extends up to the handle bar to a brake lever (illustrated in FIG. 13). Squeezing of the brake lever translates to the brake cable 1004 which results in actuation of the calliper 1003 which engages the brake disc 2002.

A second braking system (not shown) may be provided including a brake lever mounted on one of both of the hand levers 922, 923, with brake cables coupled with the brake levers extending to the brake mechanism 1001.

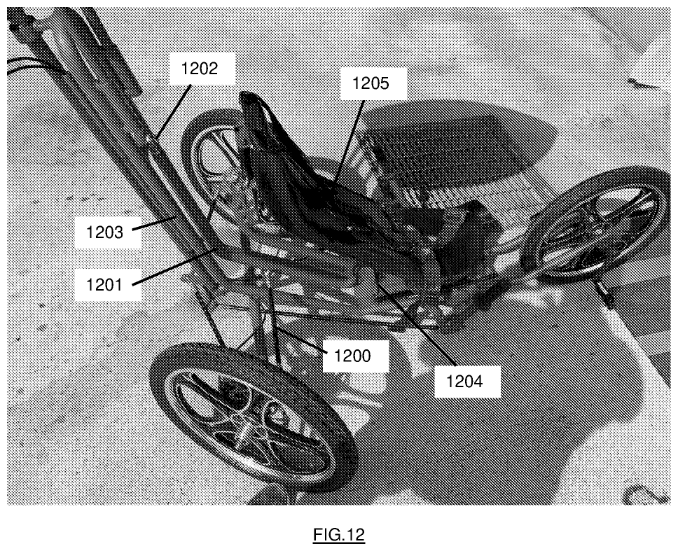

Referring additionally to FIGS. 12 and 13, the tricycle further comprises a control arm 1200 pivotally mounted on the S-shaped bracket 911 extending from the pivot 909 of the mount 905 associated with the first wheel 903. The control arm 950 is connected at an opposing end to a seat mounting rail 1201 that is pivotally mounted at a pivot 1202 on a rear portion 1203 of the chassis frame (best seen in FIG. 12). The seat mounting rail 1201 is connected with the seating mount 1204 on which the seat 1205 is mounted. Referring particularly to FIG. 11, which illustrates the connection of the control arm 1200 and the first strut 913 with the S-shaped bracket 911 more clearly, it will be appreciated that actuation of the first strut 913 results in pivoting of the S-shaped bracket 911 which translates to actuation and movement of the control arm 1200. Turning back to FIG. 12, as the tricycle is steered to the right, the control arm 1200 pulls on the seat mounting rail 1201 which tilts the seat 1205 in a first direction. Similarly, referring to FIG. 13, as the tricycle is steered to the left, the control arm 1200 pushes on the seat mounting rail 1201 which tilts the seat 1205 in an opposite direction. Tilting of the seat 1205 may be particularly advantageous in situations where engagement the back muscles of a user is desirable.

Referring again to FIG. 11, the S-shaped bracket 911 includes a lower arm 1101 on which the first strut 913 is mounted and an upper arm 1102 on which the control arm 1200 is mounted. Positioning of the first strut 913 along the lower arm 1101 is adjustable by virtue of lower apertures 1103 located in the lower arm 1101. Similarly, positioning of the control arm 1200 along the upper arm 1102 is adjustable by virtue of upper apertures 1104 located in the upper arm 1102 of the S-shaped bracket 911. This advantageously facilitates adjustment of the degree of tilt applied to the seat.

Referring to FIG. 14, briefly, a canopy 1400 is provided that is positioned on a post 1401 that extends into an upright 1402 associated with a rear portion 1403 of the chassis frame.

The physiotherapeutic conveyance was designed by the inventor as few suitable devices exist for physiotherapy of older children and adults with higher Gross Motor Function Classification System (GMFCS) classifications. What exists currently is not only expensive, but also difficult to set up and use and often will not suit older children and certainly not most adults. This mean that few children over the age of 8 are able to receive bike riding therapies. Testing in a real environment showed that with the physiotherapeutic conveyance almost four times more children alone could receive the therapy than with existing systems. These therapies can prevent or reduce the need for surgical intervention and yet be enjoyable for the recipient.

Currently special schools and other institutions delivering therapies have very limited opportunities to employ this kind of intervention due to the amount of time it takes to set up a unit. As such, these therapies tend to be used only for younger children when the existing devices are available. In most cases, as more than one career is required schools and institutions may not have the staff capability to deliver treatment frequently or even at all in many cases.

When an electrical seat is fitted to physiotherapeutic conveyance a single operator may even more easily adjust a physiotherapeutic conveyance in seconds to fit anyone and that single operator may be able to provide therapy in a safe and enjoyable way to many users than has previously been the case.

The physiotherapeutic conveyance may advantageously provide a safe method of physiotherapy for a wide range of ages and disabilities. It may require minimal training for a career to use the physiotherapeutic conveyance leading to cost and time savings. The physiotherapeutic conveyance may be simple and easy to adjust for different users, in many instances being capable of adjustment between settings for one user to another in minutes, unlike current systems. As such, a career may be able to adjust the physiotherapeutic conveyance for multiple users making it suitable for a single user or multiple users, without the need for intervention by a specialist.

More particularly, it is envisaged that the use of the physiotherapeutic conveyance may result in a reduction in the need for surgical intervention, while providing a user being treated with an enjoyable treatment experience. The physiotherapeutic conveyance may be used with a far greater range of people than many other existing systems. It provides a single device that may be capable of delivering effective therapy to multiple users. It is envisaged that the physiotherapeutic conveyance will provide a cost effective way of delivering expensive services to more people by the lowering the entry point in relation to both the physiotherapeutic conveyance and training for its use.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

Unless the context requires otherwise or specifically stated to the contrary, integers, steps or elements of the invention recited herein as singular integers, steps or elements clearly encompass both singular and plural forms of the recited integers, steps or elements.

It will be appreciated that the foregoing description has been given by way of illustrative example of the invention and that all such modifications and variations thereto as would be apparent to persons of skill in the art are deemed to fall within the broad scope and ambit of the invention as herein set forth.

1-32. (canceled)

33. A physiotherapeutic conveyance comprising:
a forwardly mounted wheel;
a chassis relative to which said forwardly mounted wheel is mounted;
a seat mounted relative to said chassis on a seating mount;
a rear axle associated with a pair of outwardly disposed first and second rear wheels; and
a steering assembly associated with said pair of outwardly disposed rear wheels, wherein
said steering assembly comprises a steering mechanism operable to adjust the orientation of said rear wheels.

34. The physiotherapeutic conveyance according to claim 33, further comprising a pair of pedals and cranks associated with opposing sides of a hub of said forwardly mounted wheel, wherein each pedal and crank are independently engageable and disengageable.

35. The physiotherapeutic conveyance according to claim 34, wherein each pedal and crank are independently engageable and disengageable via a respective clutch disposed on said hub of said forwardly mounted wheel and on either side of said forwardly mounted wheel.

36. The physiotherapeutic conveyance according to claim 35, wherein each clutch comprises a collar mounted on said hub of said forwardly mounted wheel, further comprising a plurality of locking pins, and a complementary engagement associated with a respective pedal and crank, and comprising a plurality of apertures adapted to engage said plurality of locking pins.

37. The physiotherapeutic conveyance according to claim 33, wherein said forwardly mounted wheel is mounted relative to said chassis through a front fork, wherein said front fork comprises a pair of blades that extend on either side of said forwardly mounted wheel, each of said blades comprising an extension portion that facilitates adjustment of a distance between said forwardly mounted wheel and said chassis.

38. The physiotherapeutic conveyance according to claim 37, wherein each of said extension portions comprises a plurality of apertures through which said forwardly mounted wheel can be mounted.

39. The physiotherapeutic conveyance according to claim 37, wherein a proximal end of said front fork is hingedly mounted on said chassis through a front fork hinge.

40. The physiotherapeutic conveyance according to claim 39, wherein said front fork hinge comprises a lock adapted to lock the front fork in an extended orientation for use and a retracted orientation for storage.

41. The physiotherapeutic conveyance according to claim 33, wherein a front portion of said seat is height adjustable.

42. The physiotherapeutic conveyance according to claim 41, wherein the front portion of the seat has an underside that comprises a pair of notched arms extending therefrom having notches adapted to releasably engage a lateral pin.

43. The physiotherapeutic conveyance according to claim 33, wherein the seat includes a back support portion that is adjustable to adjust the rake of the seat.

44. The physiotherapeutic conveyance according to claim 43, wherein said back support portion is coupled to a telescopic extension that extends into a housing associated with an arm that extends from said chassis.

45. The physiotherapeutic conveyance according to claim 33, wherein said steering mechanism comprises first and second struts each mounted at one end on a central pivot and on respective opposing ends mounted on first and second pivots respectively associated with the first and second wheels.

46. The physiotherapeutic conveyance according to claim 45, wherein said central pivot, said first and second pivots associated with the first and second wheels or both the central pivot and the first and second pivots associated with the first and second wheels are provided with a plurality of apertures to which said first and second struts can be mounted.

47. The physiotherapeutic conveyance according to claim 45, wherein said central pivot is connected to an upright section that extends upwardly and is connected to a handlebar.

48. The physiotherapeutic conveyance according to claim 47, further comprising a first braking system associated with said handlebar and said first and second rear wheels.

49. The physiotherapeutic conveyance according to claim 48, wherein said braking system comprises brake levers mounted on said handlebar, brake cables coupled with the brake levers and brakes coupled with the brake cables and mounted on the first and second rear wheels, respectively.

50. The physiotherapeutic conveyance according to claim 45, wherein said steering mechanism further comprises third and fourth struts, each strut being mounted at one end on the central pivot and on respective opposing ends mounted on first and second hand levers disposed at either side of said seat.

51. The physiotherapeutic conveyance according to claim 50, further comprising a second braking system associated with said hand levers and said first and second rear wheels.

52. The physiotherapeutic conveyance according to claim 33, further comprising a control arm pivotally mounted at one end on a pivot associated with one of said first and second rear wheels and connected at an opposing end to a seat mounting rail extending from the seating mount on which said seat is mounted, whereby steering of said first and second rear wheels imparts a tilt to said seat.
